(19) United States
(12) Patent Application Publication
(10) Pub. No.: US 2012/0150861 A1
(43) Pub. Date: Jun. 14, 2012

(54) HIGHLIGHTING KNOWN ANSWERS IN SEARCH RESULTS

(75) Inventors: GIOVANNI THIONE, SAN FRANCISCO, CA (US); FRANCO SALVETTI, SAN FRANCISCO, CA (US); MICHAEL BIENIOSEK, WOODINVILLE, WA (US); DAVID AHN, SAN FRANCISCO, CA (US); RICCARDO TURCHETTO, SAN FRANCISCO, CA (US); MAX LANSING, SAN FRANCISCO, CA (US); ALOK KUMAR AGARWAL, SAN FRANCISCO, CA (US)

(73) Assignee: MICROSOFT CORPORATION, REDMOND, WA (US)

(21) Appl. No.: 12/965,326

(22) Filed: Dec. 10, 2010

(51) Int. Cl. G06F 17/30

(52) U.S. Cl. 707/741; 707/E17.037

(57) ABSTRACT

Answers to search queries are identified and highlighted in search result snippets for documents containing the answers. When a user submits a search query to a search engine, the search engine may query a search index to identify a set of documents as relevant search results for the search query. Additionally, an answer data store may be queried to determine if there is a short answer to the search query. If an answer is found, the answer may be used when generating search result snippets. As such, the search result snippets for documents containing the answer may include the answer. The answer may also be highlighted in the search result snippets.

### BACKGROUND

The amount of information and content available on the Internet continues to grow exponentially. Given the vast amount of information, search engines have been developed to facilitate searching for electronic documents. In particular, users may search for information and documents by entering search queries comprising one or more terms that may be of interest to the user. After receiving a search query from a user, a search engine identifies documents and/or web pages that are relevant based on the search query. Because of its utility, web searching, that is, the process of finding relevant web pages and documents for user issued search queries has arguably become the most popular service on the Internet today.

In some instances, users may issue search queries to general web search engines with the goal of retrieving a direct answer to a specific question. For instance, a user who wishes to determine the capital of France may issue a search query such as “capital of france.” For such search queries, the web documents identified as search results often contain the answer. However, the answer may not be included as part of the search result snippets provided on the search results page presented to the user. As such, the user would need to select search results from the search results page to access documents and determine whether the documents contain the answer.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to identifying answers to search queries and highlighting the answers when they appear in search results. When a user submits a search query, a set of search results is identified for the search query. Additionally, a short answer to the search query may also be identified from an answer data store. If an answer is found for the search query, one or more answer terms may be used when generating search result snippets. As such, the answer may appear in the snippets for documents that contain the answer. The answer may also be highlighted in those snippets.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a diagram illustrating an overall process of generating search result snippets with highlighted answers in accordance with an embodiment of the present invention;

FIG. 3 is a block diagram of an exemplary system in which embodiments of the present invention may be employed;

FIG. 4 is an overall process for generating an answer store and using the answer store to identify answers that are used in generating search result snippets in accordance with an embodiment of the present invention;

FIG. 5 is a flow diagram showing a method for identifying an answer to a search query and highlighting the answer in search result snippets in accordance with an embodiment of the present invention;

FIG. 6 is an illustrative screen display showing a search input box for a search engine in accordance with an embodiment of the present invention; and

FIG. 7 is an illustrative screen display showing a search results page including search snippets with highlighted answers in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide for identifying answers to search queries and using the answers for search result snippet generation. An answer data store is generated to store answers to search queries. In some embodiments, the answers are short answers (e.g., a single word or a few words) to queries for which it is determined the user intent is to find a short answer to a question, such as “height of eiffel tower” or “capital of france.”

When a search query is received by a search engine, the search engine may query a search system index that stores data regarding searchable documents. Generally, the search system index may include information regarding documents (e.g., web documents) crawled by the search system. By querying the search index, a set of documents are identified as search results for the search query. The search engine may also analyze the search query and query the answer data store to determine whether the search query is one for which an answer may be found in the answer data store. If an answer is found, the answer is provided with an identification of the documents retrieved from the search index to a component that generates search result snippets for the search results page that is returned in response to the search query. As such, the search engine attempts to build search result snippets around the answer. In particular, if a document contains text corresponding with the answer, the search engine may generate a search result snippet for the document around the answer. Additionally, in some embodiments, the answer may be highlighted in search result snippets containing the answer. It should be noted that highlighting is used broadly herein to refer to any approach that makes presented text stand out from other text.

In some embodiments, the answer does not affect the search results selected for a search query and/or the order the search results are presented. Instead, the answer is used only for search snippet generation purposes. As such, search results may be selected for a search query and ordered as typically performed by search engines, and the answer may be employed in the process of generating snippets for the search results.

Accordingly, in one aspect, an embodiment of the present invention is directed to one or more computer storage media storing computer-useable instructions that, when used by a computing device, cause the computing device to perform a method. The method includes receiving a search query from an end user. The method also includes querying a search index based on the search query to identify a set of documents as search results for the search query. The method further includes querying an answer data store based on the search query to identify an answer for the search query. The method also includes generating search result snippets for the search results using the answer and generating a search results page with the search result snippets. The method still further includes providing the search results page for presentation to the end user.

In another embodiment, an aspect of the invention is directed to a method for highlighting an answer to a search query in search result snippets. The method includes receiving the search query from an end user. The method also includes querying a search index to identify a set of documents relevant to the search query. The method further includes querying an answer data store to determine if an answer to the search query is found in the answer data store. If an answer is not found in the answer data store, the method includes generating search result snippets without use of an answer. If an answer is found in the answer data store, the method includes generating search result snippets using the answer and applying a first highlight to the answer in search result snippets containing the answer. The method also includes applying a second highlight to search terms from the search query in search result snippets containing the search terms. The method further includes generating a search results page with the search result snippets. The method still further includes providing the search results page for presentation to the end user.

A further embodiment of the present invention is directed to a system including at least one processor and at least one computer storage medium storing a plurality of components comprising a search index querying component, an answer data store, a snippet generation component, and a user interface component. The search index querying component queries a search index to identify a set of search results relevant to a search query. The answer data store queries an answer data store to identify an answer to the search query. The snippet generation component generates search result snippets for the set of search results using the answer such that the answer is included in search result snippets for documents containing the answer. The user interface component provides a search results page that includes the search result snippets.

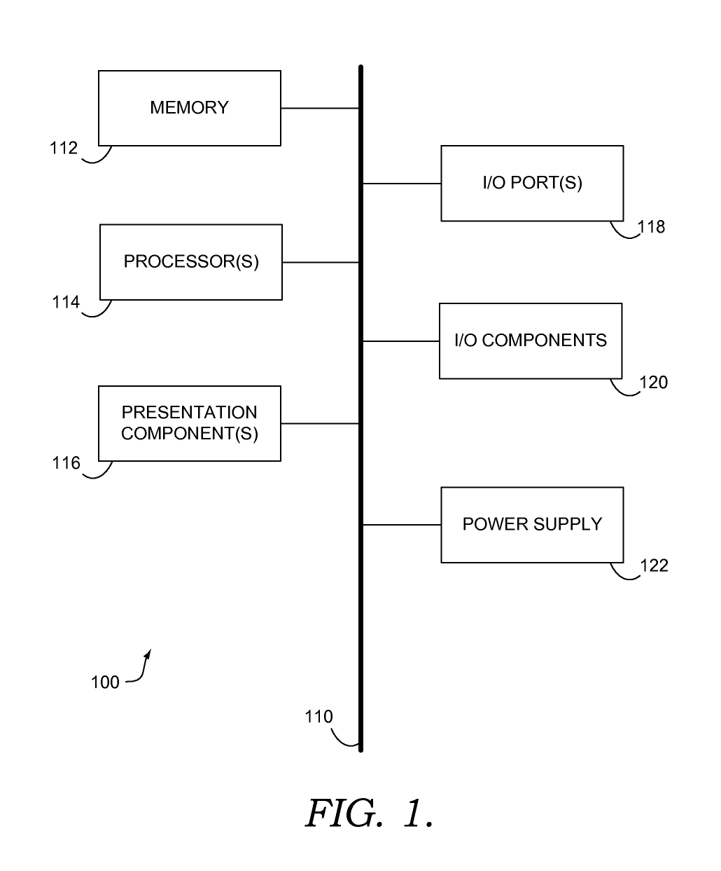

Having described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

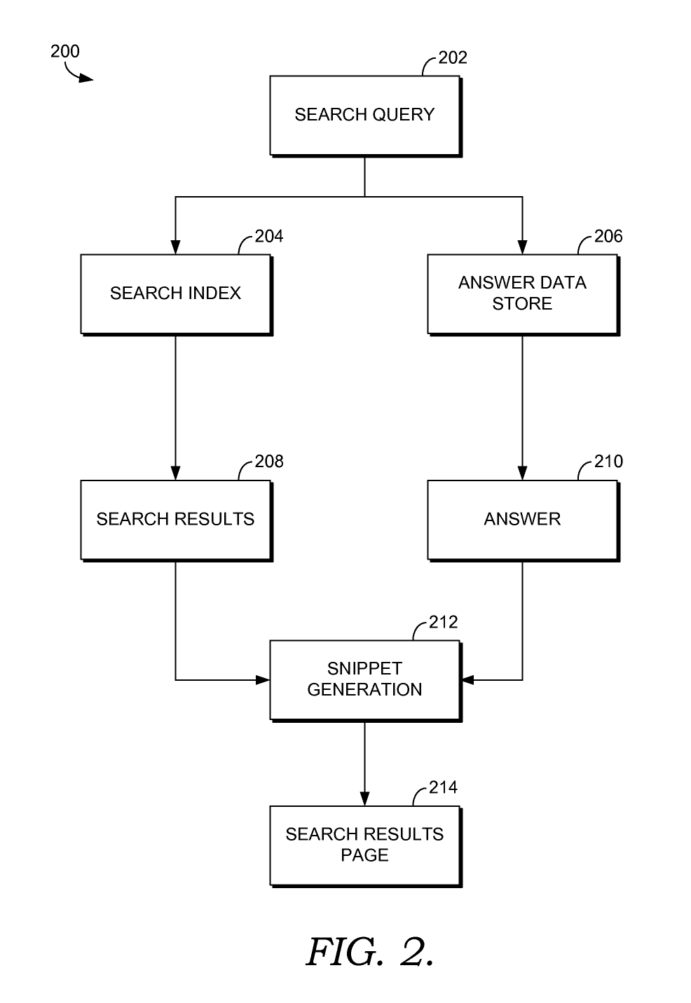

Turning to FIG. 2, a diagram is illustrated that provides an overview for identifying an answer to a search query and highlighting the answer whenever it appears in search results returned for the search query in accordance with an embodiment of the present invention. As shown in FIG. 2, when a search query 202 is received at a search engine, the search query 202 is used to search both a search index 204 and an answer data store 206. As known in the art, search engines typically crawl documents (e.g., web pages) and store information regarding the documents in a search index to facilitate returning search results to end users' search queries. When the search engine receives the search query 202, the search engine may query the search index 204 to identify documents as search results 208 that are relevant to the search query 202. The set of search results 208 may be identified as typically performed by the search engine such that no changes to the search process are needed by embodiments of the present invention.

In addition to obtaining the set of search results 208, the search engine may also query an answer data store 206 to identify an answer 210 to the search query. In embodiments, the answer data store 206 stores data that facilitates identifying answers to search queries. In particular, the search query 202 may be identified as one that is indicative of a question to which a short answer may be found. For instance, a user may submit a search query such as “capital of france.” This type of search query may have a short answer, such as “Paris” in this example.

In some embodiments, the answer data store 206 may store answers in conjunction with referring expressions that trigger each answer. As used herein, a “referring expression” is one or more words that may act as a trigger to identify an answer to a search query. Each answer in the answer data store 206 may have a number of different referring expressions that trigger the answer. The referring expressions that trigger a given answer may be different combinations of alternative formulations of words (e.g., “swiss” and “Switzerland,” “tall” and “height”). When the search query 202 is received, the search engine may determine whether the search query corresponds with a referring expression in the answer data store 206.

In some cases, an answer may not be found for a search query, and a search results page may be provided as typically done by search engines. However, in cases such as that shown in FIG. 2 in which an answer 210 is found for the search query 202, the answer 210 is employed during the snippet generation process 212 in which snippets are generated for the search results 208. As is known in the art, a snippet is an excerpt of text from a document that provides a summary of the document as a search result on a search results page. The snippet typically includes a title, summary of the document, and a document identifier (e.g., URL at which the document is located).

Search engines typically employ information regarding search queries and documents identified as search results to generate snippets. In accordance with embodiments of the present invention, the snippet generation process 212 may employ the answer 210 in addition to information regarding the search query 202 and the documents identified as search results 208 for the search query when generating snippets. The snippet generation process 212 will attempt to generate snippets that contain the answer 210. In particular, if a document identified as a search result contains text that corresponds with the answer, the snippet for that document may be generated to include the answer, as well as terms from the search query 210. Additionally, the answer may be highlighted in the snippet by presenting the answer differently from other words in the snippet. For documents that do not contain the answer, the snippets may be generally generated around terms from the search query, and the snippets for such documents will not contain the answer. As such, embodiments of the present invention provide a convenient way for end users to quickly identify search results that contain an answer to the users' queries and documents that do not.

In some embodiments of the present invention, the snippet generation process 212 may simply receive answer terms and search query terms for generating the snippets without any differentiation between the two types of terms. In other embodiments, the snippet generation process 212 may receive metadata that differentiates answer terms from search query terms. The snippet generation process 212 may employ such metadata in a number of different manners when generating snippets. In some embodiments, the snippet generation process 212 may weight answer terms and query terms differently. For instance, the snippet generation process 212 may provide greater weight to answers, such that snippets are generated that are more likely to contain answers when found in the text of documents. In some embodiments, different highlighting may be applied to the search query terms and the answer terms in the snippet. For example, the text of an answer may be underlined in a snippet while terms from the search query may be bolded.

A search results page 214 is generated that includes snippets from the snippet generation process 212. The search results page 214 is returned to the end user in response to the search query 202. As discussed, the snippets on the search results page 214 may include highlighted answers for documents that contain the answer 210 identified for the search query 202.

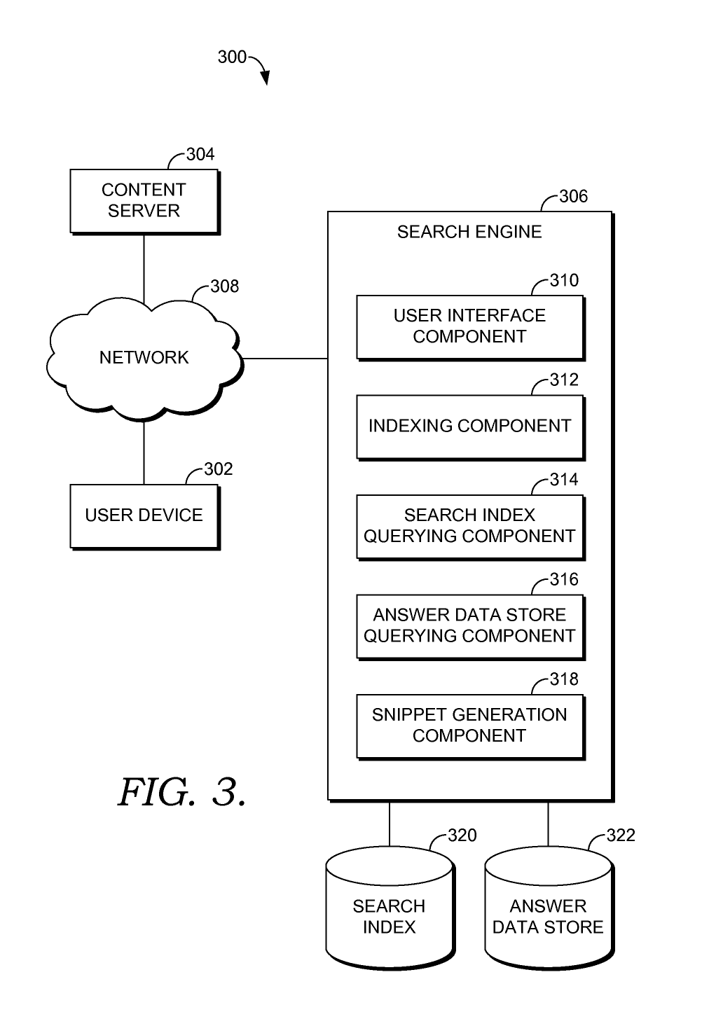

Referring next to FIG. 3, a block diagram is provided illustrating an exemplary system 300 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 300 may include a user device 302, content server 304, and search engine server 306. Each of the components shown in FIG. 3 may be any type of computing device, such as computing device 100 described with reference to FIG. 1, for example. The components may communicate with each other via a network 308, which may include, without limitation, one or more local area networks (LANs) and/or wide area networks (WANs). Such networking environments are commonplace in offices, enterprise-wide computer networks, intranets, and the Internet. It should be understood that any number of user devices, content servers, and search engine servers may be employed within the system 300 within the scope of the present invention. Each may comprise a single device or multiple devices cooperating in a distributed environment. For instance, the search engine server 306 may comprise multiple devices arranged in a distributed environment that collectively provide the functionality of the search engine server 306 described herein. Additionally, other components not shown may also be included within the system 300.

In the embodiment shown in FIG. 3, the search engine server 306 includes, among other things, a user interface component 310, an indexing component 312, a search index querying component 314, an answer data store querying component 316, and a snippet generation component 318.

The search engine server 306 generally operates to receive search queries from user devices, such as the user device 302, and to provide search results in response to the search queries. The user interface component 310 provides an interface to user devices, such as the user device 302, that allows users to submit search queries to the search engine server 306 and to receive search results from the search engine server 306. The user device 302 may be any type of computing device employed by a user to submit search queries and receive search results. By way of example only and not limitation, the user device 302 may be a desktop computer, a laptop computer, a tablet computer, a mobile device, or other type of computing device. The user device 302 may include an application that allows a user to enter a search query and submit the search query to the search engine server 306 to retrieve search results. For instance, the user device 302 may include a web browser that includes a search input box or allows a user to access a search page to submit a search query. Other mechanisms for submitting search queries to search engines are contemplated to be within the scope of embodiments of the present invention.

The indexing component 312 operates to index data regarding documents maintained by content servers, such as the content server 304. For instance, a crawling component (not shown) may be employed to crawl content servers and access information regarding documents maintained by the content servers. The indexing component 312 then indexes data regarding the crawled documents in the search index 320, which is employed to retrieve search results in response to search queries.

When the search engine 306 receives a search query from an end user (e.g., from user device 302), the search index querying component 314 operates by using the search query to query the search index 320 and identify documents that are relevant to the search query. This provides a set of ranked search results. Additionally, the answer data store querying component 316 operates by using the search query to query the answer data store and determine whether an answer may be found for the search query. In some embodiments, the answer data store querying component 316 may analyze the search query and determine whether the search query corresponds with a referring expression that triggers an answer in the answer data store 322. If so, the answer is retrieved from the answer data store 322.

The snippet generation component 318 receives information regarding the search query, the documents identified as search results, and the answer. Based on this information, the snippet generation component 318 generates a snippet for each of the search results. Because the answer is provided to the snippet generation component 318, the answer is used in generating snippets. Accordingly, if a document contains the answer, the snippet may be generated to include the answer. Additionally, the answer may be highlighted in the snippet. Highlighting an answer may include presenting the text of the answer in the snippet differently from the text of other words in the snippet. By way of example only and not limitation, the answer may be highlighted by employing bolding, italics, underlining, all caps, a different font, a different font size, or a different text color.

In some embodiments, the snippet generation component 318 may treat search query terms and answer terms the same when generating search result snippets. In such embodiments, the query terms and answer terms will be used equally to generate the snippets. In other embodiments, the snippet generation component 318 may receive metadata that identifies answer terms and query terms as such. The snippet generation component 318 may use such information when generating the snippets. For instance, the snippet generation component 318 may apply different weighting to answer terms and query terms to influence the likelihood that each will be extracted from the text of documents and included in the snippets. In some embodiments, greater weight is given to answer terms to increase the likelihood that the answer will be displayed in snippets for documents containing the answer.

In further embodiments, the snippet generation component 318 may employ metadata identifying answer terms and query terms to apply different highlighting in snippets. For instance, only answer terms may be highlighted or only query terms may be highlighted. As another example, answer terms and query terms may all be highlighted but different highlighting could be applied. For instance, an answer may be underlined while terms from the search query may be bolded.

A search results page is generated using the snippets from the snippet generation component 318. The search results page is then provided via the user interface component 310 to a user device (e.g., the user device 302) for presentation to the end user who submitted the search query.

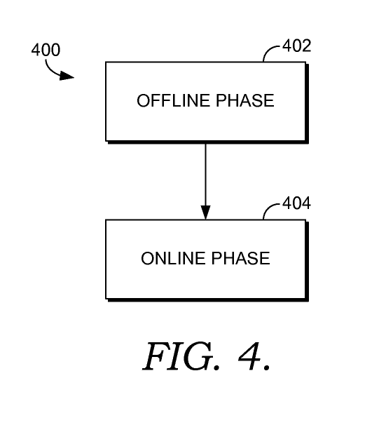

As can be understood and as represented in FIG. 4, an overall process 400 for identifying answers to search queries and highlighting the answers in search results in accordance with embodiments may generally include two main phases. The first phase is an offline phase 402 in which an answer data store is built. As discussed previously, the answer data store contains data that may be used to identify answers to search queries. The second phase is an online phases 404 in which search queries from end users are used to identify answers to the search queries using the answer data store and to employ the answers when generating snippets for the search results.

Referring initially to the offline phase 402, the answer data store may be generated and structured using any of a variety of different techniques. By way of example only and not limitation, the answer data store in one embodiment may comprise structured data that relates concepts and attributes regarding the concepts to attribute values that may serve as answers. For instance, a concept may be “France,” an attribute may be “capital,” and the attribute value may be “Paris.” As such, the attribute value “Paris” could serve as an answer to a query such as “capital of france.” In such embodiments, the structured data may comprise concept-attribute-value triples. However, other types of data structures may be employed to store answers in accordance with other embodiments of the present invention.

In some embodiments, referring expressions may be identified for answers in the answer data store and used to trigger answers in response to search queries. As discussed previously, a “referring expression” is one or more words that when included in a search query cause an answer to be identified for the search query. Each answer may have a number of different referring expressions that trigger the answer. The referring expressions may comprise different combinations of various alternative formulations of words. The referring expressions for answers in the answer data store may be identified in a number of different manners in various embodiments of the present invention. For instance, in some embodiments, referring expressions may be manually generated for answers. In other embodiments, referring expressions may be algorithmically identified, for instance, by monitoring user click behavior on a search engine.

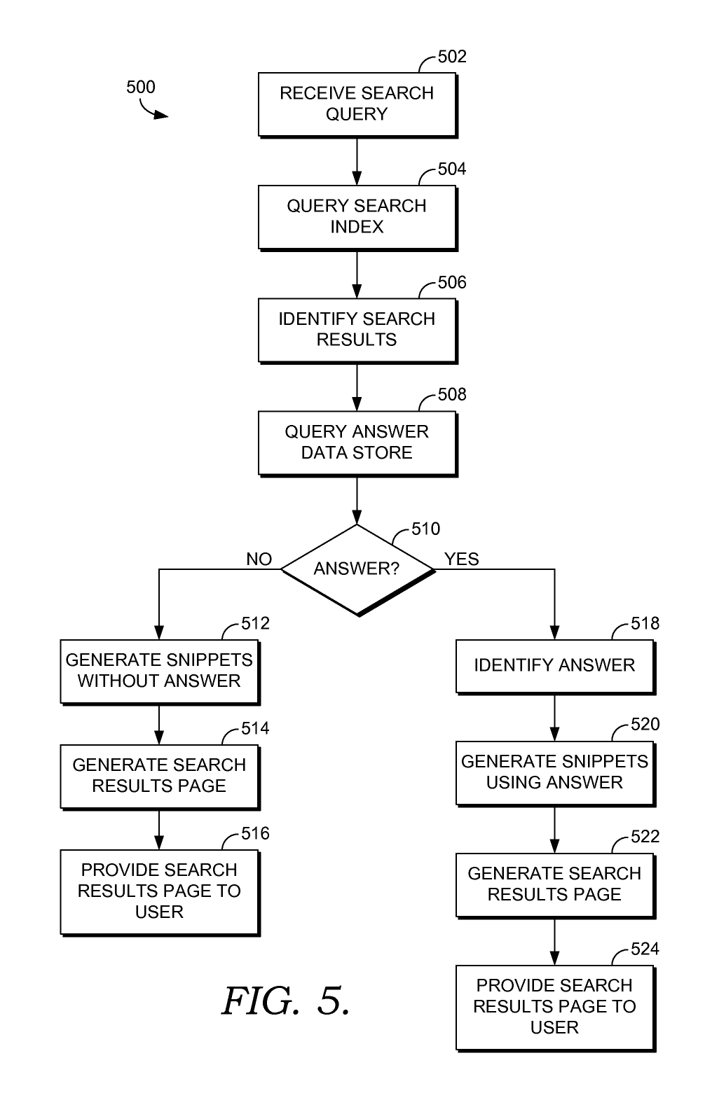

As noted above, the online phase 404 generally operates to identify answer to search queries and generate snippets for the search queries to include the answer for documents containing the answer. Referring now to FIG. 5, a flow diagram is provided that illustrates a method 500 for generating snippets with highlighted answers in accordance with an embodiment of the present invention. As shown at block 502, a search query is received from an end user. The search query is employed to query a search index, as shown at block 504. By querying the search index, a number of documents are identified as search results to the search query, as shown at block 506.

In addition to querying the search index, an answer data store is also queried based on the search query, as shown at block 508. In some embodiments, this may include determining whether the search query corresponds with a referring expression that triggers an answer stored in the answer data store. This may include, for instance, determining if the search query is within a certain edit distance of a referring expression or contains certain terms contained in a referring expression.

A determination is made at block 510 regarding whether an answer to the query is found in the answer data store. For instance, a matching referring expression may or may not be found for the search query. If an answer to the search query is not found, snippets are generated for the search results without use of an answer, as shown at block 512. Additionally, a search results page is generated at block 514 and provided to the end user at block 516. Because an answer to the search query was not found, the snippets on the search results page will not highlight any answer.

Alternatively, if an answer is found for the search query, the answer is identified, as shown at block 518. The answer is then employed to generate snippets for the search results, as shown at block 520. This may include identifying the answer in documents with text corresponding with the answer, and generating the snippet for such document based on that text. Additionally, the answer may be highlighted in the snippets for documents containing the answer. In further embodiments, the snippets may also be built around search query terms. In some cases, the answer and query terms may be given different weighting when generating the snippets. In further cases, the answer and query terms may be given different highlighting in snippets.

A search results page is generated with the snippets, as shown at block 522. Additionally, the search results page is provided to the end user at block 524. The search results page is presented such that the answer is highlighted in any snippet that contains the answer. In some embodiments, the answer may also be provided in addition to the search results. For instance, the answer may be provided as text above and separate from the list of search results.

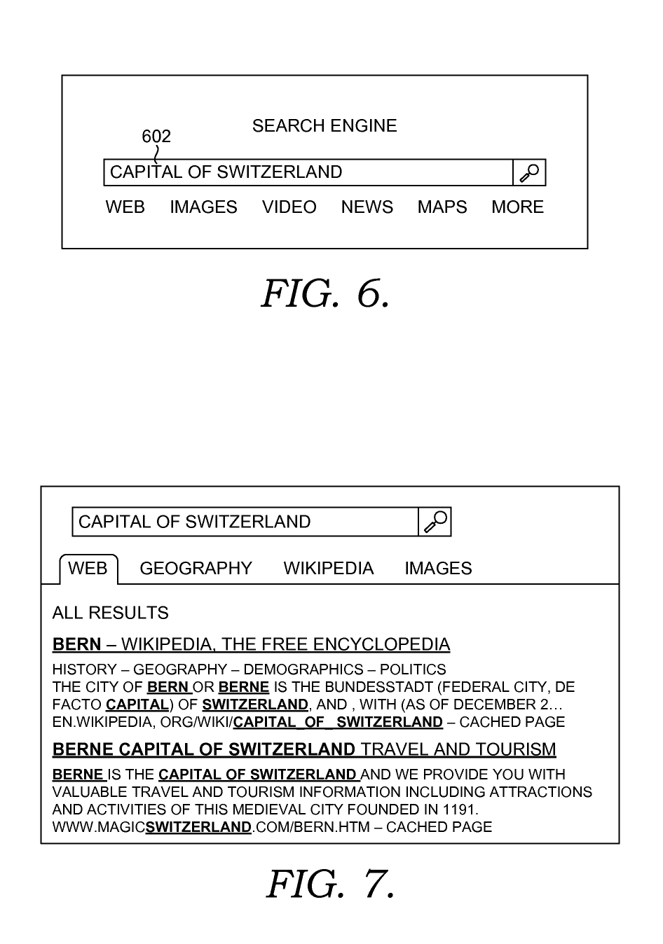

Referring now to FIG. 6 and FIG. 7, exemplary screen displays are provided illustrating search results being returned in response to a user search query in which answers are highlighted in search result snippets in accordance with an embodiment of the present invention. It will be understood and appreciated by those of ordinary skill in the art that the screen displays of FIGS. 6 and 7 are provided by way of example only and are not intended to limit the scope of the present invention in any way.

Referring initially to FIG. 6, an exemplary screen display of a search user interface is shown. The search interface includes a search input box 602 that may be provided, for instance, via a search engine web page. The search input box 602 allows a user to enter a search query for search purposes. By inputting a search query in the search input box 602, a user may cause the search engine to perform a search using the inputted search query.

In the present example, the user has entered the terms “capital of switzerland” as the search query in the search input box 602. In response to the user search query, the search engine performs a search and prepares a search results page containing search results, as shown in the screen display of FIG. 7. In accordance with embodiments of the present invention, to provide the search results page, the search engine may identify the answer to the query “capital of switzerland” as “Berne” and may generate search result snippets with the highlighted answer. As shown in FIG. 7, a number of search results are included on the search results page with the text of the answer “Berne” highlighted in the snippet for each document containing the answer. In particular, the text “Berne” is bolded and underlined in the snippets. As shown in FIG. 7, search query terms “capital” and “Switzerland” are also bolded and underlined in the snippets. Although not shown in FIG. 7, any search result snippet corresponding with a document that does not contain the answer will not include the highlighted answer.

As can be understood, embodiments of the present invention provide for the identification of answers to search queries and highlighting of answers in search result snippets. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by a computing device, cause the computing device to perform a method comprising:
receiving a search query from an end user;
querying a search index based on the search query to identify a set of documents as search results for the search query;
querying an answer data store based on the search query to identify an answer for the search query;
generating search result snippets for the search results using the answer;
generating a search results page with the search result snippets; and
providing the search results page for presentation to the end user.

2. The one or more computer storage media of claim 1, wherein querying an answer data store based on the search query to identify the answer comprises identifying a referring expression that triggers the answer and that corresponds with at least a portion of terms in the search query.

3. The one or more computer storage media of claim 1, wherein generating the search result snippets comprises:
identifying one or more search terms from the search query;
identifying one or more answer terms from the answer; and
employing the one or more search terms and the one or more answer terms to generate the search result snippets.

4. The one or more computer storage media of claim 3, wherein generating the search result snippets further comprises weighting the one or more search terms differently than the one or more answer terms when generating the search result snippets.

5. The one or more computer storage media of claim 4, wherein the one or more answer terms are given higher weighting than the one or more search terms.

6. The one or more computer storage media of claim 1, wherein the answer is highlighted by presenting text of the answer differently from text of other terms in the search result snippets.

7. The one or more computer storage media of claim 6, wherein the text of the answer is presented differently from the text of other terms by applying one or more of the following to the text of the answer: bolding, italics, underlining, all caps, a different font, a different font size, and a different text color.

8. The one or more computer storage media of claim 6, wherein generating the search result snippets further comprises highlighting query terms in search results snippets containing the query terms.

9. The one or more computer storage media of claim 8, wherein the method includes applying a first highlight to the answer and a second highlight for the query terms in the search results snippets, wherein the first highlight and second highlight are different.

10. A method for highlighting an answer to a search query in search result snippets, the method comprising:
receiving the search query from an end user;
querying a search index to identify a set of documents relevant to the search query;
querying an answer data store to determine if an answer to the search query is found in the answer data store;
if an answer is not found in the answer data store, generating search result snippets without use of an answer;
if an answer is found in the answer data store, generating search result snippets using the answer and applying a first highlight to the answer in search result snippets containing the answer;
applying a second highlight to search terms from the search query in search result snippets containing the search terms;
generating a search results page with the search result snippets; and
providing the search results page for presentation to the end user.

11. The method of claim 10, wherein querying an answer data store comprises identifying a referring expression that triggers the answer and that corresponds with at least a portion of the search terms in the search query.

12. The method of claim 10, wherein if an answer is found in the answer data store, generating the search result snippets comprises:
identifying one or more search terms from the search query;
identifying one or more answer terms from the answer; and
employing the one or more search terms and the one or more answer terms to generate the search result snippets.

13. The method of claim 12, wherein generating the search result snippets further comprises weighting the one or more search terms differently than the one or more answer terms when generating the search result snippets.

14. The method of claim 13, wherein the one or more answer terms are given higher weighting than the one or more search terms.

15. The method of claim 10, wherein applying the first highlight to the answer comprises applying one or more of the following to text of the answer in search result snippets:
bolding, italics, underlining, all caps, a different font, a different font size, and a different text color.

16. The method of claim 10, wherein applying the second highlight to search terms comprises applying one or more of the following to text of the search terms in search result snippets: bolding, italics, underlining, all caps, a different font, a different font size, and a different text color.

17. The method of claim 10, wherein the first highlight and the second highlight are different.

18. A system including at least one processor and at least one computer storage medium storing a plurality of components comprising:
a search index querying component that queries a search index to identify a set of search results relevant to a search query;
an answer data store that queries an answer data store to identify an answer to the search query;
a snippet generation component that generates search result snippets for the set of search results using the answer such that the answer is included in search result snippets for documents containing the answer; and
a user interface component that provides a search results page that includes the search result snippets.

19. The system of claim 18, wherein the snippet generation component highlight answer terms and search query terms in the search result snippets.

20. The system of claim 19, wherein the answer terms and search query terms are highlighted differently.
